(19) United States
(12) Patent Application Publication
(10) Pub. No.: US 2016/0162152 A1
(43) Pub. Date: Jun. 9, 2016

(54) METHOD TO INDIRECTLY DETECT A USER INPUT

(71) Applicant: ACCO Brands Corporation, Lake Zurich, IL (US)

(72) Inventor: Gerald A. Gutierrez, Richmond (CA)

(21) Appl. No.: 14/559,505

(22) Filed: Dec. 3, 2014

(51) Int. Cl. G06F 3/0481; G06F 11/30; G06F 3/0484

(52) U.S. Cl. CPC G06F 3/04812; G06F 3/0484; G06F 11/3089

(57) ABSTRACT

A method of indirectly detecting a user input including running an operating system on a computer device. The operating system receives information directly from an input device. The method also includes running an application module on the computer device. The application module is configured to receive information from the input device indirectly by monitoring changes to a textbox made by the operating system in response to information received from the input device. The method also includes generating a textbox, populating the textbox with a matrix of characters, and positioning a cursor at a predetermined starting location within the textbox by the application module. The method further includes monitoring the textbox for changes caused by the operating system, detecting a change in a position of the cursor within the textbox, and performing, by the application module, a specific action in response to a direction of movement of the cursor.

### BACKGROUND

The present invention relates to indirectly detecting a user input from an external input device.

### SUMMARY

In one embodiment, the invention provides a method of indirectly detecting a user input. The method includes running an operating system on a computer device. The operating system receives information directly from an input device. The method also includes running an application module on the computer device. The application module is configured to receive information from the input device indirectly by monitoring changes to a textbox made by the operating system in response to information received from the input device. The method further includes generating a textbox by the application module, populating the textbox by the application module with a matrix of characters, and positioning a cursor at a predetermined starting location within the textbox by the application module. Furthermore, the method includes monitoring, by the application module, the textbox for changes caused by the operating system, detecting, by the application module, a change in a position of the cursor within the textbox, and performing, by the application module, a specific action in response to a direction of movement of the cursor.

In another embodiment the invention provides a computer device including a processor and a memory storing instructions that, when executed by the processor, cause the computer device to run an operating system. The operating system is configured to receive a user input from an external input device, communicate with an application module by changing the contents of a text box generated by the application module, and change a position of a cursor within the textbox generated by the application module in response to receiving an input from the external input device indicative of a pressing of the control key. The instructions, when executed by the processor also cause the computer to run the application module. The application module is configured to generate the textbox, populate the textbox with an initial matrix of characters, and position the cursor at a starting location within the textbox. The application module is also configured to determine whether the cursor shifts position within the textbox in response to a change made by the operating system, and perform an action when the application module determines that the cursor shifts position.

Other aspects of the invention will become apparent by consideration of the detailed description and accompanying drawings.

### BRIEF DESCRIPTION OF THE DRAWINGS

FIG. 1 is a perspective view of a computer system according to one embodiment of the invention.

FIG. 2 is a perspective view of different types of external input devices of the computer system shown in FIG. 1.

FIG. 3 is a schematic diagram of the external input device.

FIG. 4 is a schematic diagram of a computer device of the computer system shown in FIG. 1.

FIG. 5 is a flowchart for a method of indirectly detecting key presses.

FIG. 6 is a graphical representation of a textbox used to detect the key presses.

FIG. 7 is a graphical representation of an alternative textbox used to detect the key presses.

FIG. 8 is a graphical representation of the textbox of FIG. 6 in response to an “up arrow” input from an external device.

FIG. 9 is a graphical representation of the textbox of FIG. 6 in response to a “down arrow” input from an external device.

FIG. 10 is a graphical representation of the textbox of FIG. 6 in response to a “left arrow” input from an external device.

FIG. 11 is a graphical representation of the textbox of FIG. 6 in response to a “right arrow” input from an external device.

FIG. 12 is a graphical representation of the textbox of FIG. 6 in response to a “backspace” input received through a keyboard.

FIG. 13 is a graphical representation of the textbox of FIG. 6 in response to an alphanumeric input received through a keyboard.

FIG. 14 is a flowchart for an alternative method of indirectly detecting key presses.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

Some computer devices provide an operating system by executing instructions stored on a non-transitory computer-readable memory. The operating system manages and integrates the capabilities of the computer device and serves one or more application modules by providing interaction with the various capabilities of the computer device. Application modules are provided by executing instructions stored on the non-transitory computer-readable memory of the computer device and perform specific tasks for the user. For example, a user may start an application module to send e-mails (e.g., an e-mail application), or to manage a presentation (e.g., PowerPoint®).

Many computer devices accept external input devices to receive user input to interact with the various application modules. The operating system in many computer devices receives a signal from the external input device indicating which key or keys were pressed on the external input device. The operating system then transmits the keyboard press information to the application module. The application module performs an appropriate action based on the key that was pressed by the user. For example, if the application module includes a presentation application, the user may press a forward arrow key to show a new presentation slide on a display of the computing device (e.g., the next slide).

Some computer devices (e.g., an IPAD®), however, execute an operating system that does not transmit keyboard press information directly to the application modules. Instead, the application modules on these computer devices create textboxes that are updated by the operating system in response to system inputs (e.g., user inputs from a keyboard). The application module then determines which characters have been inputted by analyzing the textboxes.

Such computer devices can receive inputs from two types of “keys”: a control key and an alphanumeric key. A control key refers to a key on the keyboard that does not include a displayable character (e.g., letters, numbers, and symbols). Rather, the control key performs a function. For example, an input from an arrow key moves the cursor, a backspace key deletes a preceding displayable character, a space key shifts the cursor forward, etc. Some control keys cannot be detected by analyzing the textbox because they do not cause a displayable change to the textbox. Because, in such computer devices, the application modules do not have direct access to keyboard press information, the application module does not receive any indication from the operating system when a control key is pressed instead of a displayable character.

Some application modules on such computer devices, however, would benefit from receiving information regarding the user's interaction with the external keyboard. For example, as discussed above, a presentation application may change slides when a particular key (e.g., an arrow key) is pressed. A method for an application module to indirectly detect when a user presses particular keys using an external input device is discussed below. The application module can then perform specific actions based on the user input from the external input device.

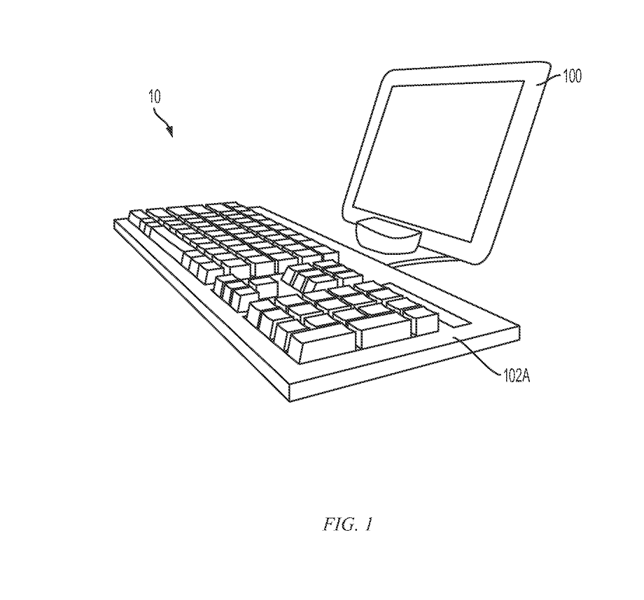

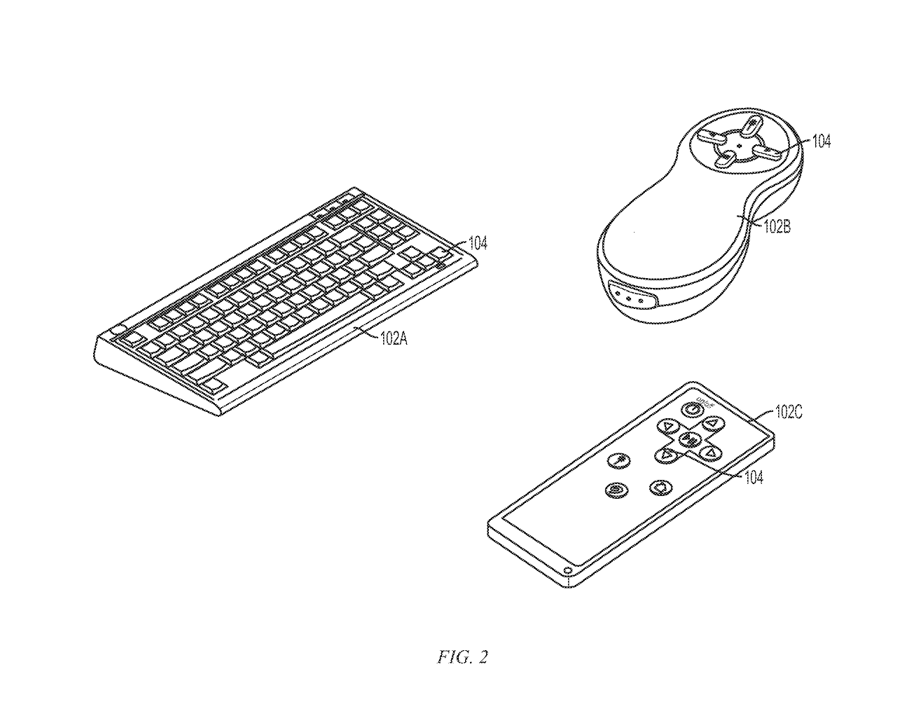

FIG. 1 illustrates a system 10 including a computer device 100 connected to an external input device 102A. The external input device 102A receives physical user inputs and transmits a signal indicative of the user input to the computer device 100. Although the example of FIG. 1 shows the external input device as a keyboard 102A, the external input device 102 can be a variety of different devices. For example, as illustrated in FIG. 2, the external input device can be an external keyboard 102A, a remote presenter 102B, a remote control 102C, etc. All such external input devices are referred to collectively by reference numeral 102 below.

Each external input device 102 includes a plurality of keys 104. In some embodiments, the external input device 102 includes both displayable keys (i.e., characters, numbers, and symbols) and control keys (e.g., arrow keys, backspace, etc.), as in the case of the external keyboard 102A. In other embodiments, the external input device 102 (e.g., the remote presenter 102B and the remote control 102C) includes control keys, but few or no displayable characters.

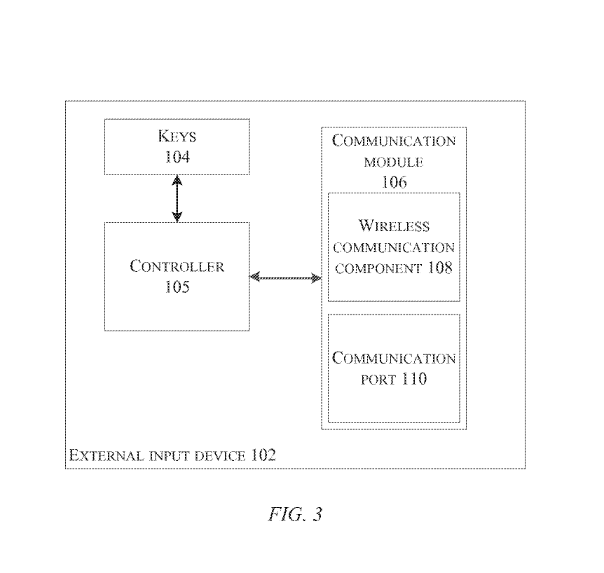

In some embodiments, as illustrated in FIG. 3, the external input device 102 includes a controller 105 that detects the physical user input (i.e., a pressed key) and controls the communication module 106 to transmit a signal indicative of input key presses to the computer device 100. In the example of FIG. 3, the communication module 106 includes both a wireless communication component 108 and a communication port 110. The wireless communication component 108 can include, for example, a Bluetooth® transceiver and controller, a WiFi enabled transceiver, an RFID transceiver, or another wireless communication transceiver. The communication port 110 provides for wired communication with the computer device 100 and may include, for example, a USB port, a miniUSB port, a proprietary port, an RS232 port, or another similar communication port that enables information exchange. In the illustrated embodiment, the external input device 102 includes both the wireless communication components 108 and the communication port 110. In such embodiments, the user may select which communication to use based on accessible resources and user preference. However, in other constructions, the external input device 102 includes only the wireless communication component 108 or the communication port 110.

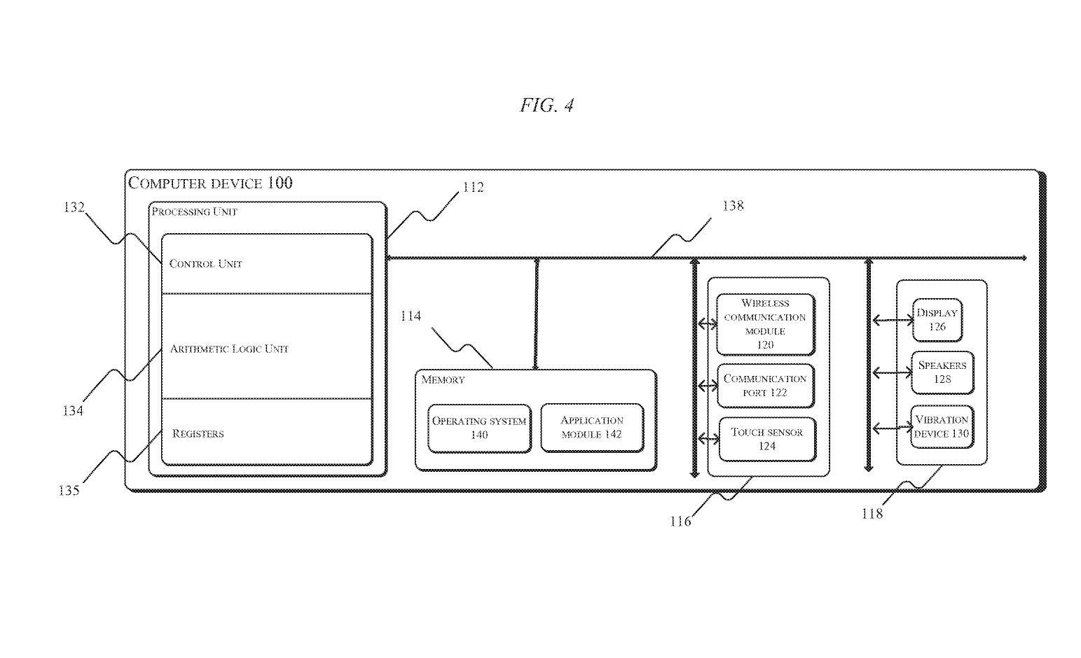

As shown in FIG. 4, the computer device 100 includes a plurality of electrical and electronic components that provide power, operational control, and protection to the components and modules within the computer device 100. For example, the computer device 100 includes a processing unit 112 (e.g., a microprocessor, a microcontroller, or another suitable programmable device), a memory 114, input units 116, and output units 118. The input units 116 include components configured to receive user inputs. For example, the input units 116 can include a wireless communication module 120 configured to communicate with the external input device 102. The input units 116 can alternatively or additionally include a communication port 122 configured to communicate with the external input device 102 or another electronic device such as, for example, a portable media player. The input units 116 can also include sensors to receive user inputs. In the illustrated embodiment, the input units 116 also include a touch sensor 124 configured to detect user touches on a screen of the computer device 100. For example, the computer device 100 can detect user input on an on-screen keyboard using the touch sensor 124.

The output units 118 include components that provide feedback to the user. The output units 118 can include, for example, a display 126, speakers 128, a vibration device 130, etc. The computer device 100 may include more or less output units 118. The display 126 is configured to display graphical user interfaces generated by the processing unit 112 and may display user inputs (e.g., displayable characters). The display 126, the speakers 128, and the vibration device 130 may respond to user inputs based on instructions from the processing unit 112.

The processing unit 112 includes, among other things, a control unit 132, an arithmetic logic unit (“ALU”) 134, and a plurality of registers 136 (shown as a group of registers in FIG. 3). The processing unit 112 is implemented using a known computer architecture, such as a modified Harvard architecture, a von Neumann architecture, etc. The processing unit 112, the memory 114, the input units 116, and the output units 118 are connected by one or more control and/or data buses (e.g., common bus 138).

The memory 114 includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic optical, physical, or electronic memory devices. The processing unit 112 is connected to the memory 114 and executes software instructions that are capable of being stored in a RAM of the memory 114 (e.g., during execution), a ROM of the memory (e.g., on a generally permanent basis), or another non-transitory computer readable medium such as another memory or disc.

The computer device 100 provides an operating system by executing operating system instructions 140 stored in memory 114. The operating system 140 performs basic functions for the computer device 100. For example, the operating system 140 receives inputs from the input units 116, including, for example, from the external input device 102, sends output to the display 126 and the other output units 118, tracks files and/or directories on memory 114. In some embodiments, the operating system 140 may also determine which users are granted authorized access to the computer device 100. Examples of operating systems 140 include Linux, Windows, Android, iOS, BSD, OS X, QNX, IBM z/OS, etc. The operating system 140 also provides a software platform on which application modules (e.g., application programs) can operate.

The computer device 100 also provides at least one application module by executing application module instructions 142 stored in memory 114. When executed by the processing unit 112, the application module 142 interacts with the operating system 140 (provided concurrently by executing the operating system instructions 140). In the illustrated embodiment, the application module 142 includes a presentation application 142. The presentation application 142 allows a user to create a presentation, edit a presentation, and display a presentation. The presentation application 142 instructs the operating system 140 to generate a graphical user interface that allows the user to create, edit, and display presentations. For example, the presentation application 142 may allow a user to add a slide to the presentation, populate the slide with pictures, text, media, etc., change the order of the slide among the other slides in the presentation, and enter a view presentation mode in which the presentation is shown for presentation. The user can advance slides, go back slides, activate media objects, end the slideshow, etc. In other embodiments, the computer device 100 may store more application modules 142 and each application module may provide different functionality to the user. For example, the computer device 100 may alternatively or additionally include an e-mail application module, a word processing application module, a database application module, etc.

In the illustrated embodiment, the operating system 140 provides limited input information to the application module 142. For example, the operating system 140 receives user input through the external input device 102 and simply notifies the application module 142 when a textbox is updated or changed. Therefore, the application module 142 generates different textboxes, allows the operating system 140 to populate the textboxes, and then analyzes the content of the textboxes to determine which characters have been inputted by the user from the external input device 102.

In particular modes of the presentation application 142, the presentation application 142, however, also performs specific actions when certain control keys are pressed by the user. In the illustrated embodiment, the presentation application 142 enters the view presentation mode before performing actions associated with some control keys. While the presentation application 142 remains in the view presentation mode, the application module 142 continues to perform the specific actions when the application module 142 determines that the associated control keys are pressed. In other embodiments, the presentation application 142 may automatically perform specific actions when certain control keys are pressed regardless of the mode of the presentation application 142.

The presentation application 142 executes the method illustrated in FIG. 5 to indirectly detect when the user inputs a particular key using the external input device 102, without necessarily alerting the user that such detection is taking place. First, the presentation application 142 receives a user input from the internal input units 116 (e.g., the touch sensor) for the presentation application 142 to execute a particular mode such as, for example, a view presentation mode (step 144). The user's selection of the particular mode signals the application module 142 (e.g., the presentation application) to begin indirect detection of keys pressed by the user.

In response to entering the view presentation mode, the application module 142 generates a textbox 160 as illustrated in FIG. 6. The textbox 160 is not displayed and is hidden from a user's view. The textbox 160 runs in the background of the application module 142. Because the operating system 140 is able to make changes to the contents of the text box based on inputs received from various input units 116, the application module 142 detects actuation of keys on the external input device 102 by monitoring changes and/or updates to the textbox 160. The application module 142 populates the textbox 160 with an initial set of displayable characters, monitors changes in the textbox 160, and compares the changes in the textbox 160 to known or expected changes. In particular, the application module 142 determines which keys 104 are actuated by monitoring the position of a cursor within the textbox 160. The text cursor indicates a position where text is to be edited based on user input. In other embodiments, the text cursor may also be referred to as a caret. The text cursor is referred to simply as “cursor” for the remainder of the application. As shown in FIG. 6, the textbox 160 is populated with an initial matrix of displayable characters to allow the application module to virtually map (e.g., track) the position of the text cursor within the textbox 160 (step 148). In the illustrated embodiment, the textbox 160 is populated with an initial matrix including two character columns and three character rows.

The application module 142 then positions the cursor at a predetermined starting location (step 150). The starting location is at the center of the textbox 160. In other words, the cursor is positioned in the second character row between a first character column and a second character column as shown in FIG. 6. In the illustrated embodiment, because the character matrix includes more than one row and more than one column, the application module 142 can track the cursor and determine a position shift of the cursor in four different directions (i.e., up, down, right, left).

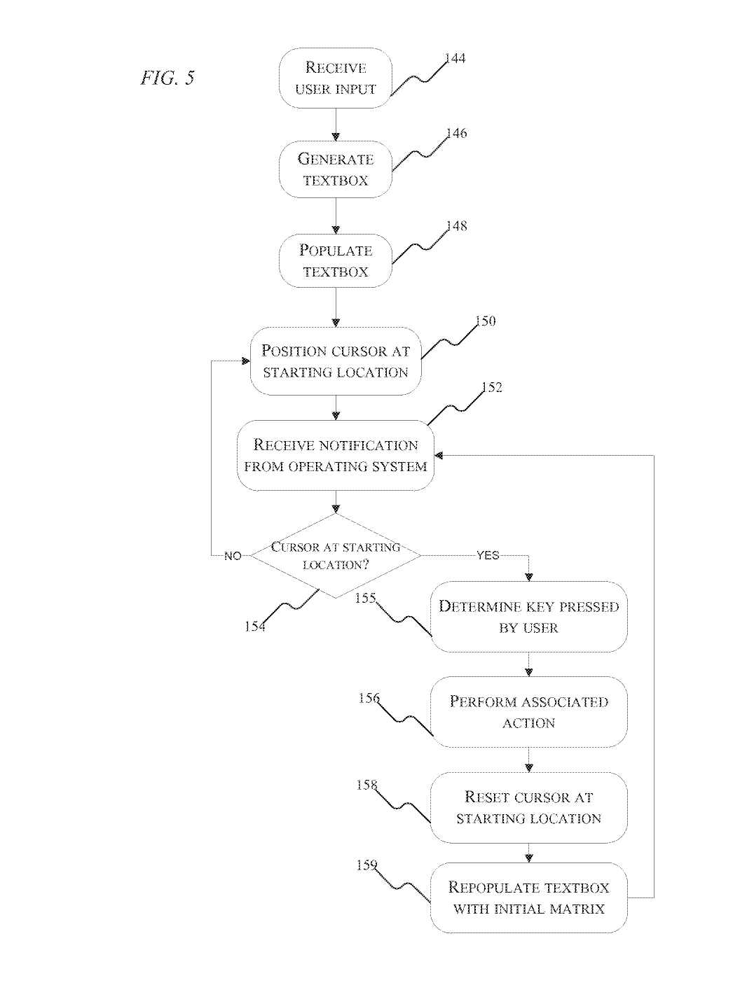

In other embodiments, the initial matrix of characters may have different dimensions. For example, in some embodiments, the textbox 160 may be populated with a two character columns and a single character row, as shown in FIG. 7. In such embodiments, the application module 142 can determine the position shift (i.e., the movement) of the cursor in two directions (i.e., left and right). In other embodiments, the application module 142 populates the textbox 160 with a matrix having two character columns and three character rows, as shown in FIG. 6, but only detects the position shift of the cursor in two directions (i.e., up and down). In yet other embodiments, the matrix of characters includes more or less characters based on how many and which directions the application module 142 monitors the position of the cursor.

According to the method of FIG. 5, when the operating system 140 alters the contents of the textbox in response to a user input (i.e., shifting the cursor, editing the text, etc.), the operating system 140 sends a notification to the application module 142 that the textbox 160 is updated (step 152). The application module 142 then analyzes the textbox 160 to determine the position of the cursor and compare the position of the cursor to the starting location (step 154). If the application module 142 determines that the cursor shifted position, the application module 142 then determines which key press causes the observed position shift in the cursor (step 155). In the illustrated embodiment, the application module 142 detects six different key presses by the user. In particular, the application module 142 determines whether a control key was pressed, and if so, determines which control key was pressed.

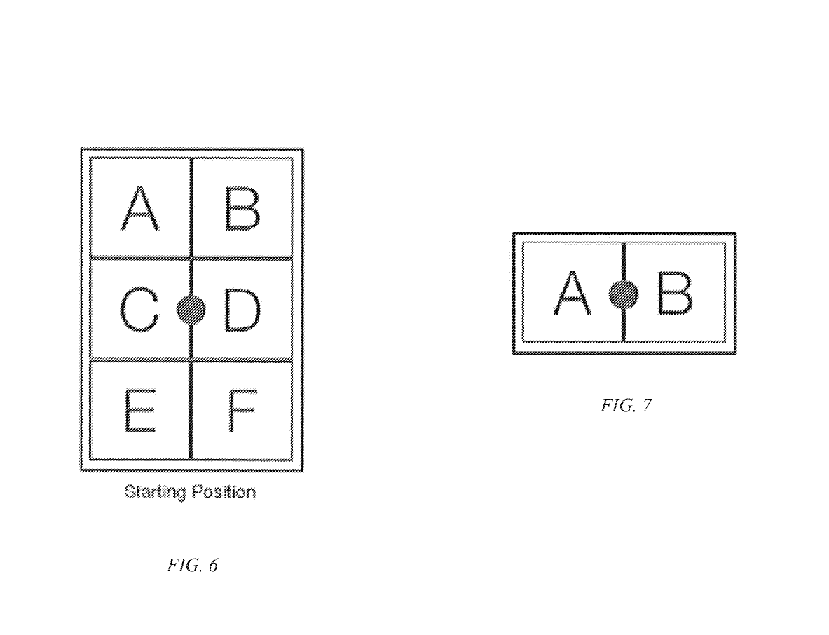

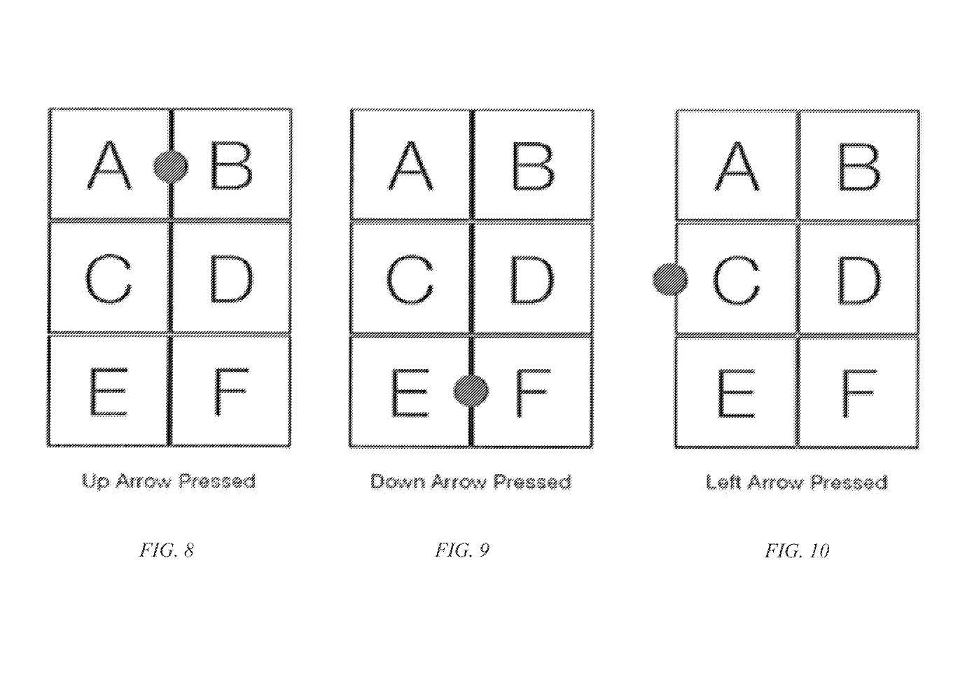

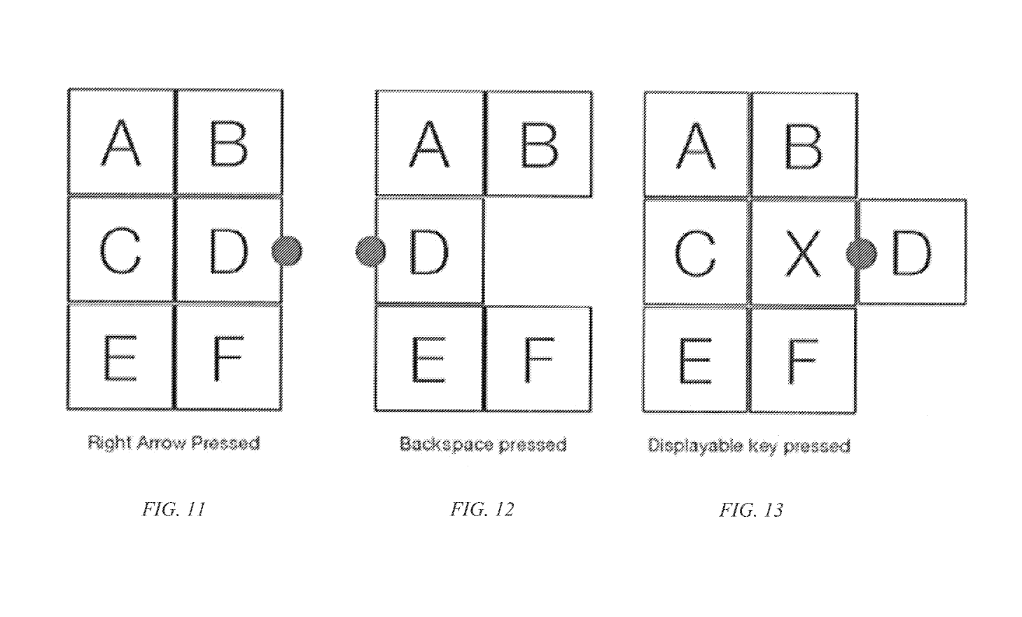

When the application module 142 determines that the cursor shifted position upward and the character matrix remains unchanged (see FIG. 8), the application module 142 determines that an upward arrow was pressed by the user on the external input device 102. When the application module 142 determines that the cursor shifted position downward and the character matrix remains unchanged (see FIG. 9), the application module 142 determines that a downward arrow was pressed by the user on the external input device 102. When the application module 142 determines that the cursor shifted position to the left and the character matrix remains unchanged (see FIG. 10), the application module 142 determines that a left arrow was pressed by the user on the external input device 102. When the application module 142 determines that the cursor shifted position to the right and the character matrix remains unchanged (see FIG. 11), the application module 142 determines that a right arrow was pressed by the user on the external input device 102.

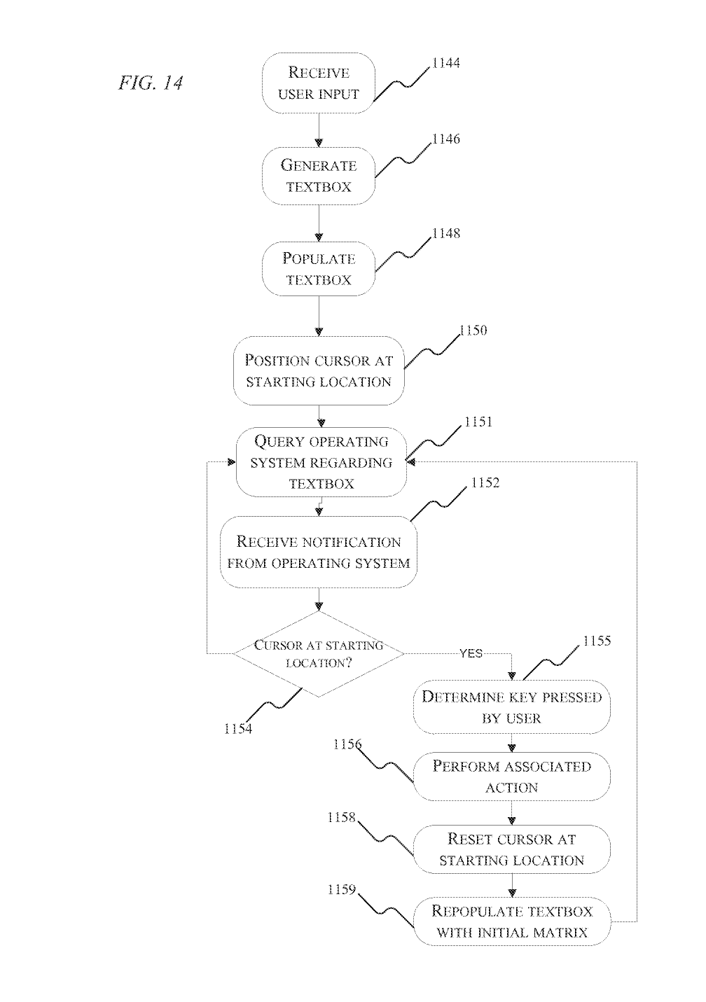

As noted above, the operating system 140 updates the textbox based on user inputs. Therefore, in some embodiments, a user input from an alphanumeric key on a keyboard or a control key (e.g., a backspace) can also cause the operating system 140 to alter the contents of the text box. For example, as illustrated in FIG. 12, a pressed backspace key will cause the operating system 140 to delete one of the alphanumeric values in the textbox matrix. When the application module 142 determines that the cursor has shifted position to the left and the character matrix includes one less character (see FIG. 12), the application module 142 is able to determine that a backspace key was pressed by the user on the external input device 102. Similarly, a pressed alphanumeric key will cause the operating system 140 to add an additional alphanumeric character to the textbox matrix. When the application module 142 determines that the cursor has shifted position to the right and the character matrix includes one more character (see FIG. 13), the application module 142 determines that a displayable character was pressed.

In some embodiments, the application module 142 stores a particular position shift of the cursor with a specific key press. In other words, the application module 142 may store a table that indicates that when the cursor shifts position upward and the character matrix remains unchanged, an upward key was pressed, etc. In other embodiments, the application module 142 may not store a table, but may instead store a set of rules that allow the application module 142 to determine which position shift of the cursor corresponds to which key press. Therefore, by tracking the position and the position shift of the cursor, the application module 142 determines if a key was pressed by the user, if the key pressed by the user is a control key, and in some instances, which control key was pressed by the user.

Once the application module 142 determines which key was pressed by the user on the external input device 102, the application module 142 performs an action associated with the particular key (step 156). As discussed above, the presentation application 142 may change the display to the next slide when a forward arrow is pressed by the user on the external input device 102, and may change the display to the previous slide when a backward arrow is pressed by the user on the external input device 102. Other application modules 142 may have different actions associated with the control keys detected by the application module 142 through the textbox 160. For example, an e-mail application may change the display to a next e-mail when the down arrow key is pressed by the user on the external input device 102. In some embodiments, the application module 142 may have a different action associated with each detected control key press. In other embodiments, the application module 142 may detect different control key presses, but may have an associated action with only a portion of the detected control key presses.

After the application module 142 analyzes the textbox information from the operating system 140, the application module 142 resets the cursor to the starting location (step 158) and repopulates the textbox with the initial matrix of characters (step 159), so that the next key pressed by the user is detected in a similar manner as described above. However, in other embodiments, the cursor is not reset to the starting location, but is instead tracked throughout the character matrix. In other words, the application module 142 compares the current position of the cursor within the textbox 160 with the previous position of the cursor. The application module 142 then continues to track the location of the cursor and determine which key was pressed by the user on the external input device 102.

FIG. 14 illustrates an alternative method for the application module 142 to track the cursor position. The method of FIG. 14 includes similar steps to those shown with respect to FIG. 5, and similar steps have been given similar reference numbers plus 1000. In the illustrated method, the application module 142 periodically queries the operating system 140 for the position of the cursor within the textbox 160 (step 1151). The operating system 140 then responds to the information request from the application module 142 relaying any information regarding the textbox 160 (step 1152). The application module 142 then determines whether the cursor shifted position based on the information within the response from the operating system 140. The application module 142 then follows similar steps to those outlined above with respect to FIG. 5. In another embodiment, the application module 142 sends a request to the operating system 140 for automatic notifications regarding the position of the cursor. The operating system 140 receives the request (similar to step 1151) and begins sending notifications to the application module 142 when the cursor shifts position (similar to step 152 of Fig.5). The application module 142 then follows similar steps to those outlined above with respect to FIG. 5.

Thus, the invention provides, among other things, a method for an application module to indirectly determine whether a particular key was pressed on an external input device based on the location of a cursor within a textbox. Various features and advantages of the invention are set forth in the following claims.

What is claimed is:

1. A method of indirectly detecting a user input, the method comprising:
running an application module on the computer device, the application module configured to receive information from an input device indirectly by monitoring changes made by an operating system to a textbox in response to information received from the input device;
generating a textbox by the application module;
populating the textbox by the application module with an initial matrix of characters;
positioning a cursor at a predetermined starting location within the textbox by the application module;
monitoring, by the application module, the textbox for changes caused by the operating system in response to information received by the operating system from the input device;
detecting, by the application module, a change in a position of the cursor within the textbox, the change caused by the operating system in response to information received from the input device; and
performing, by the application module, a specific action in response to a direction of movement of the cursor.

2. The method of claim 1, wherein generating a textbox includes generating a hidden, non-displayed textbox.

3. The method of claim 1, wherein populating the textbox includes populating the textbox with the initial matrix of characters having at least three characters, the characters arranged adjacent each other.

4. The method of claim 1, wherein populating the textbox includes populating the textbox with the initial matrix of characters having at least two character columns and at least three character rows.

5. The method of claim 1, wherein positioning the cursor includes positioning the cursor at the center of the initial matrix of characters.

6. The method of claim 5, wherein the initial matrix of characters includes a first character column, a second character column, a first character row, a second character row, and a third character row, and wherein positioning the cursor at the center of the initial matrix includes positioning the cursor between the first and second columns of the second character row of the matrix.

7. The method of claim 1, wherein detecting a change in a position of the cursor within the textbox includes receiving a notification from the operating system at the application module, the application module receiving the notification when the cursor shifts position.

8. The method of claim 1, wherein detecting a change in position of the cursor within the textbox includes sending a request for information regarding the position of the cursor from the application module to the operating system, receiving a response at the application module from the operating system regarding the position of the cursor, and detecting a change in position of the cursor based on the response from the operating system.

9. The method of claim 8, wherein sending a request for information includes periodically sending a request for information regarding the position of the cursor from the application module to the operating system.

10. The method of claim 1, further comprising determining, by the application module, whether a control key was pressed based on the change in position of the cursor.

11. The method of claim 10, wherein determining whether a control key was pressed includes determining whether an arrow key was pressed based on whether the matrix of characters is unchanged and the position of the cursor is changed.

12. The method of claim 11, wherein performing a specific action includes changing a display on the computer device to a next screen of a presentation when a forward arrow key is pressed.

13. The method of claim 1, further comprising repopulating, by the application module, the textbox with the initial matrix of characters.

14. The method of claim 1, further comprising receiving a user input by the application module, and wherein generating the textbox includes generating, by the application module, the textbox in response to the user input.

15. The method of claim 1, further comprising resetting, by the application module, the cursor to the starting location.

16. A computer device comprising:
a processor and a memory storing instructions that, when executed by the processor, cause the computer device to
run an application module, the application module configured to
generate the textbox,
populate the textbox with an initial matrix of characters,
position the cursor at a starting location within the textbox,
monitor the textbox for changes caused by an operating system in response to information received from an input device, the information indicative of a user input,
detect a change in a position of the cursor within the textbox, the change caused by the operating system in response to information received from the input device, and
perform an action in response to the change in position of the cursor.

17. The computing system of claim 16, wherein the starting location is positioned at the center of the matrix of characters.

18. The computing system of claim 16, wherein the application module is configured to receive a notification from the operating system when the cursor shifts position in the textbox.

19. The computing system of claim 16, wherein the application module is further configured to send a request to the operating system for information regarding the position of the cursor, receive a response from the operating system, the response including information regarding the location of the cursor, and determine whether the cursor shifts position based on the response from the operating system.

20. The computing system of claim 16, wherein the application module is further configured to determine whether an arrow key was pressed.

21. The computing system of claim 20, wherein the application module is configured to determine that an arrow key was pressed when the matrix of characters is unchanged and the position of the cursor shifts.

22. The computing system of claim 16, wherein the operating system is configured to receive a user input and send a signal indicative of the user input to the application module, and wherein the application module is configured to receive the user input directly from the operating system, and generate the textbox in response to the user input.

23. The computing system of claim 16, wherein the application module is configured to reset the cursor to the starting location after determining whether the cursor shifts position within the textbox.

24. The computing system of claim 16, wherein the application module is configured to repopulate the textbox with the initial matrix of characters.
